(19) United States
(12) Patent Application Publication
(10) Pub. No.: US 2014/0338931 A1
(43) Pub. Date: Nov. 20, 2014

(54) Liquid Wet Chemical Fire Extinguishing Spray

(71) Applicant: BRK Brands, Inc., Boca Raton, FL (US)

(72) Inventors: Vincent Mori, Plainfield, IL (US); Robert Challman, Naperville, IL (US); Mark Binter, Downers Grove, IL (US); Stephen Latham, Sun Prairie, WI (US); John Boland, Madison, WI (US); Kent Kallsen, Jefferson, WI (US); Jesse Darley, Madison, WI (US); Dave Franchino, Madison, WI (US)

(73) Assignee: BRK Brands, Inc., Boca Raton, FL (US)

(21) Appl. No.: 14/288,037

(22) Filed: May 27, 2014

Related U.S. Application Data
(63) Continuation-in-part of application No. 12/440,551, filed on Mar. 9, 2009, now abandoned.
(60) Provisional application No. 60/843,866, filed on Sep. 11, 2006.

(51) Int. Cl. A62C 13/64; G01L 19/08; A62C 5/02

(52) U.S. Cl. CPC A62C 13/64; A62C 5/02; G01L 19/08
USPC 169/71; 222/23; 116/212

(57) ABSTRACT

An aerosol fire extinguisher for dispensing a liquid wet chemical fire extinguishing agent, and a composition for the liquid wet chemical fire extinguishing agent, where the liquid wet chemical fire extinguishing agent is rated for class A, B, C and K fires. The fire extinguisher includes a container and a valve assembly affixed to the container. A hag is positioned within the container, where the bag includes an output tube connected in fluid communication to the valve assembly. An actuator is connected in fluid communication to the valve assembly opposite the output tube, where. the actuator has an elongated output orifice. A liquid wet chemical fire extinguishing agent is disposed within the bag and a propellant is disposed within the container, wherein the bag isolates the liquid wet chemical fire extinguishing agent from the propellant. The: configuration of the elongated output orifice expels the liquid wet chemical fire extinguishing agent in a substantially planar pattern onto the fire.

### CROSS-REFERENCE TO RELATED APPLICATION

This application is a Continuation-in-Part of U.S. application Ser. No. 12/440,551 entitled LIQUID WET CHEMICAL FIRE EXTINGUISHING SPRAY , filed on Mar. 9, 2009, which claims the benefit of U.S. Provisional Application No. 60/843,866 for LIQUID FIRE SUPPRESSANT, filed on Sep. 11, 2006, the content of which is herein incorporated by reference in its entirety.

### FIELD OF THE INVENTION

The disclosure relates to an aerosol hand held fire extinguisher, and more particularly, to an aerosol hand held fire extinguisher for dispensing a liquid wet chemical fire extinguishing spray and the composition thereof.

### BACKGROUND OF THE INVENTION

Fires can be categorized in the United States into five basic classes: Class A fires are fires in ordinary combustible material, eg., wood, cloth, paper, rubber, and many plastics; Class B fires are fires in flammable and combustible liquids, gases, and greases; Class C fires are fires that involve energized electrical equipment where the electrical non-conductivity of the extinguishing media is of importance; Class D fires are fires that involve combustible metals; and Class K fires are fires that involve cooking oils or fats. In each of the classes, the formation and continuation of the fire requires three basic elements; heat, fuel, and an oxidizing agent. By removing one of these elements the fire can be extinguished.

Different types of portable fire extinguishers have become useful in extinguishing the different classes of fires. The most common types of portable fire extinguishers are; water, CO₂, and dry chemical, where each of these types has its usefulness on different classes of fires. For Class A fires water and dry chemical fire extinguishers are recommended. For Class B and C fires CO₂ and dry chemical extinguishers are recommended. For Class D fires dry chemical extinguishers are recommended. For Class K fires wet chemical extinguishers are recommended.

However, each of these types of extinguishers has its own disadvantages. For example, you would never use a water extinguisher on a cooking oil, grease or electrical fire. As water is insoluble with cooking oil or grease, the water will cause flare up spreading the oil or grease, the flames and making the fire bigger. Similarly, as water is a good conductor of electricity, the use of this on an electrical fire can be dangerous for the user. Furthermore, water extinguishers tend to be pressurized with oxygen.

CO₂ extinguishers contain carbon dioxide, a non-flammable gas, and are highly pressurized. The pressure is so great that it is not uncommon for bits of dry ice to shoot out the actuator (nozzle).

Dry chemical extinguishers are filled with chemicals that leave a residue. In B:C type dry chemical extinguishers, the residue can be corrosive, difficult to clean and must be cleaned immediately to prevent damage to surrounding materials. In A:B:C type dry chemical extinguishers, the residue can be sticky, difficult to clean and damaging to surrounding materials.

### SUMMARY OF THE INVENTION

The present disclosure recites an aerosol fire extinguisher for dispensing a liquid wet chemical fire extinguishing spray. The fire extinguisher includes a container and a valve assembly affixed to the container. A bag is positioned within the container, where the bag includes an output tube connected in fluid communication to the valve assembly. An actuator (nozzle) is connected in fluid communication to the valve assembly opposite the output tube, where the actuator has an elongated output orifice. A liquid wet chemical fire extinguishing agent is disposed within the bag and a propellant is disposed within the container, wherein the bag isolates the liquid wet chemical fire extinguishing agent from the propellant.

The liquid wet chemical fire extinguishing agent includes the following ingredients:

CH₃CHOHCO₂H (Lactic Acid);

KOH (Potassium Hydroxide); and

H₂O.

The liquid wet chemical fire extinguishing spray can further include: K₂CO₃ (Potassium Carbonate) and KHCO₃ (Potassium Bicarbonate).

In an exemplary embodiment, the liquid wet chemical fire extinguishing agent can include:

| | |
|---|---|
| CH₃CHOHCO₂H (Lactic Acid) | 17-43 vol. % |
| KOH (Potassium Hydroxide) | 18-48 vol. % |
| K₂CO₃ (Potassium Carbonate) | 0-23 vol. % |
| KHCO₃ (Potassium Bicarbonate) | 0-23 vol. % |
| H₂O | Balance of volume |

In a method of using the fire extinguisher to extinguish a fire, the elongated orifice is directed at the fire. The actuator is depressed to open the valve. The liquid wet chemical fire extinguishing agent is expelled onto the fire, where the elongated output orifice expels the agent in a substantially planar pattern.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a front isometric view of a fire extinguisher including the liquid wet chemical fire extinguishing spray of the present disclosure;

FIG. 2 depicts a front isometric sectional view of the fire extinguisher of FIG. 1;

FIG. 3 depicts a bag of the fire extinguisher of FIG. 1;

FIG. 4 depicts a cross sectional view of a fluid dispensing actuator of the present disclosure;

FIG. 4A depicts a top cross sectional view of the fluid dispensing actuator of FIG. 4;

FIG. 5 depicts a substantially planar spray pattern of the fire extinguisher of FIG. 1;

FIG. 6 depicts a method of using the fire extinguisher of FIG. 1

FIG. 7 depicts a front isometric sectional view of the fire extinguisher of FIG. 1 including a pressure indicator;

FIG. 8 depicts a side sectional view of an embodiment of a pressure indicator in a first position;

FIG. 9 depicts a side sectional view of the pressure indicator of FIG. 8 in a second position;

FIG. 10 depicts a side sectional view of an another embodiment of a pressure indicator in a first state; and

FIG. 11 depicts a side sectional view of the pressure indicator of FIG. 10 in a second state.

### DETAILED DESCRIPTION OF THE INVENTION

The present disclosure is directed to an aerosol fire extinguisher for dispensing a liquid wet chemical fire extinguishing spray, and a composition for the liquid wet chemical fire extinguishing agent, where the agent is rated for class A, B, C and K fires. The liquid wet chemical fire extinguishing agent is dispensed though an actuator having an elongated output orifice. The configuration of the elongated output orifice expels the liquid wet chemical fire extinguishing agent in a substantially planar pattern onto the fire. Additionally, the actuator dispenses the liquid wet chemical fire extinguishing agent through the elongated output orifice at a reduced particle size, where the reduced particle size is sufficiently small to increase the air gap between particles and decrease or eliminate the electrical conductivity of the dispensed liquid wet chemical fire extinguishing agent in Class C fires.

Referring now to the drawing figures in which like reference designators refer to like elements, there is shown in FIGS. 1 and 2 a fire extinguisher 10. The fire extinguisher 10 include a substantially cylindrical container 20 having top and bottom ends 22 and 24, and defining a hollow interior space 26. A valve member 28 is positioned on and affixed to the top end 22 of the container 20. A fluid dispensing actuator (nozzle) 30 is connected to the valve member 28.

Referring to FIGS. 2 and 3, a bag 32 is positioned within the interior space 26 of the container 20. The bag 32 includes an output tube 34 having a first end 36 positioned within the interior 38 of the bag 32 and a second end extending 40 from a top end 42 of the bag 32. The top end 42 of the bag 32 is sealed about the output tube 34, such that the contents 44 of the bag 32 are isolated from the interior space 26 of the container 20. The second end 40 of the output tube 34 is connected to the valve member 28, such that the valve member 28 is in fluid communication with the contents 44 in the interior 38 of the bag 32.

The bag 32 can be a non-permeable bag, preventing the passing or diffusion of liquids or gases through the bag. Additional exemplary bags 32 are described in U.S. Pat. No. 5,169,037 and U.S. Reissue Pat. No. RE35,540, the contents of which are herein incorporated by reference in their entirety.

The valve member 28 includes a downwardly extending stem 46 to which the fluid dispensing actuator 30 is connected. A downward depression of the fluid dispensing actuator 30 depresses the downwardly extending stem 46, opening the valve member 28. In this manner, the contents 44 of the bag 32 are free to flow through the output tube 34, the downwardly extending stem 46, an ultimately through the fluid dispensing actuator 30. Since the operations of the valve member 28 are well known in the prior art, they will not be described herein.

The hollow interior space 26 of the container 20 is charged with a pressurized gas (propellant) 48, such that the bag 32 and contents 44 are maintained under pressure. In this manner, a depression of fluid dispensing actuator 30 opens the valve member 28, resulting in a release of the contents 44 from bag 32 through the fluid dispensing actuator 30. Furthermore, as the bag 32 is sealed from the interior space 26 of the container 22, no propellant 48 is released from the interior space 26 of the container 20 with the contents 44 of the bag 32.

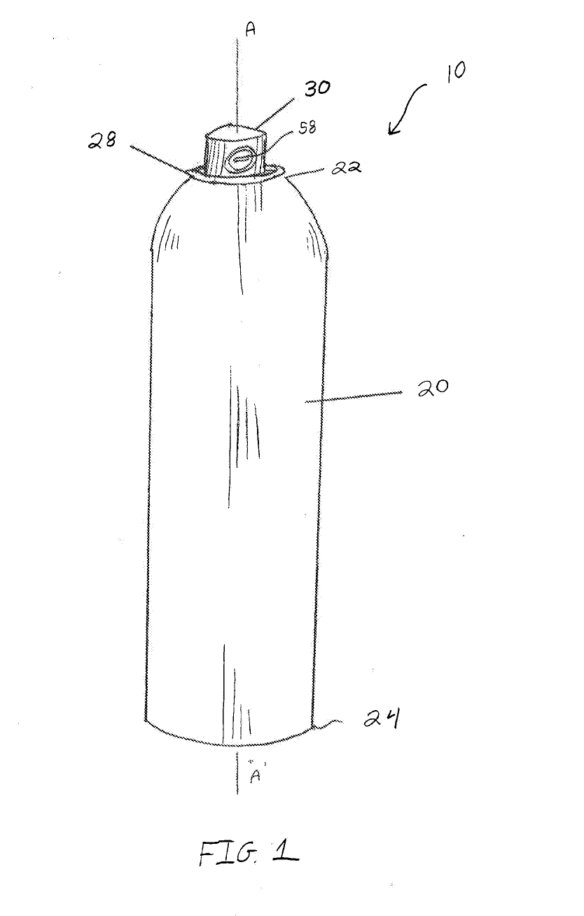

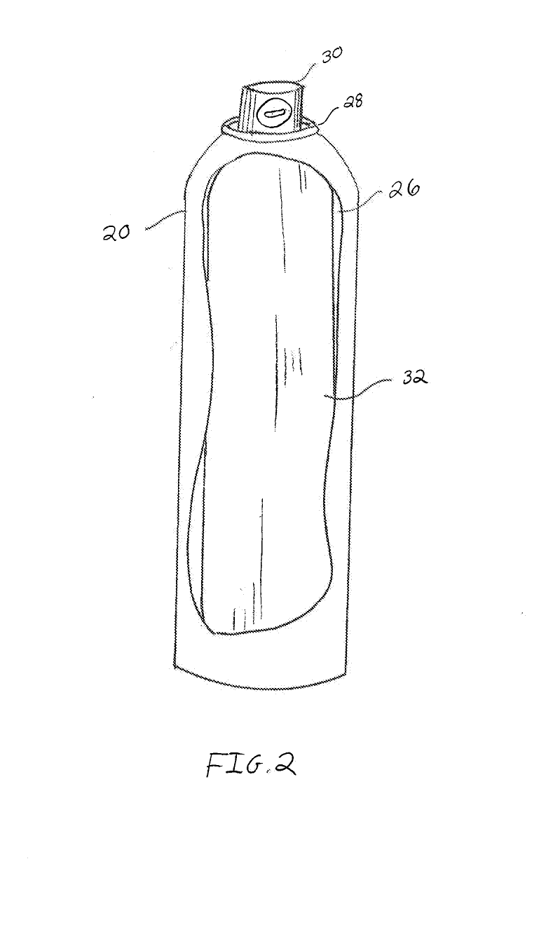

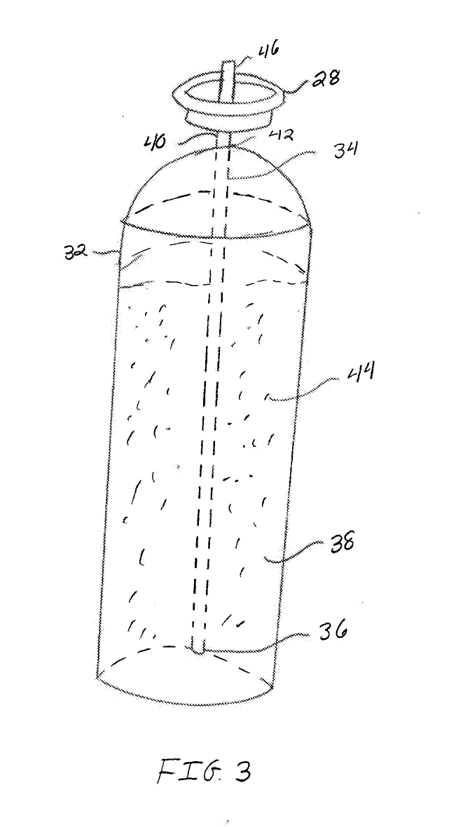

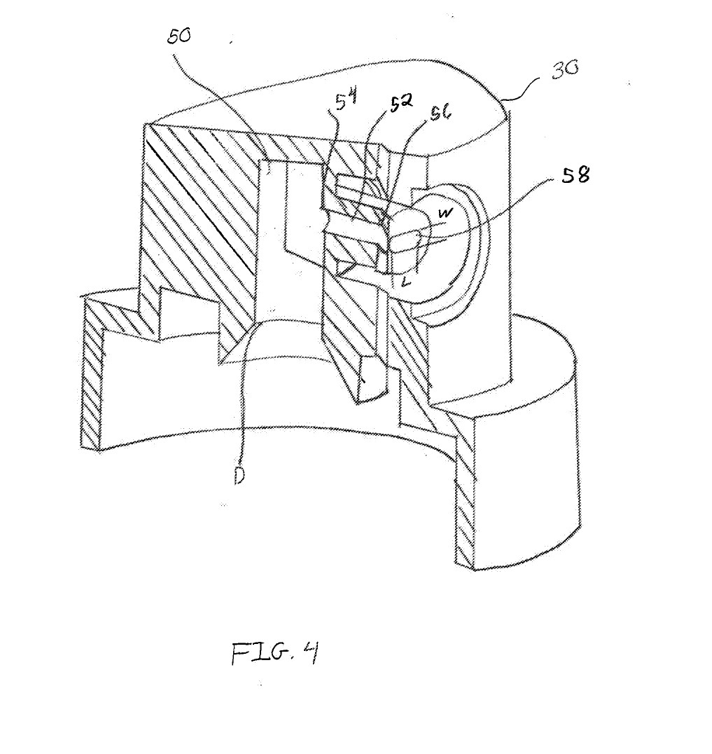

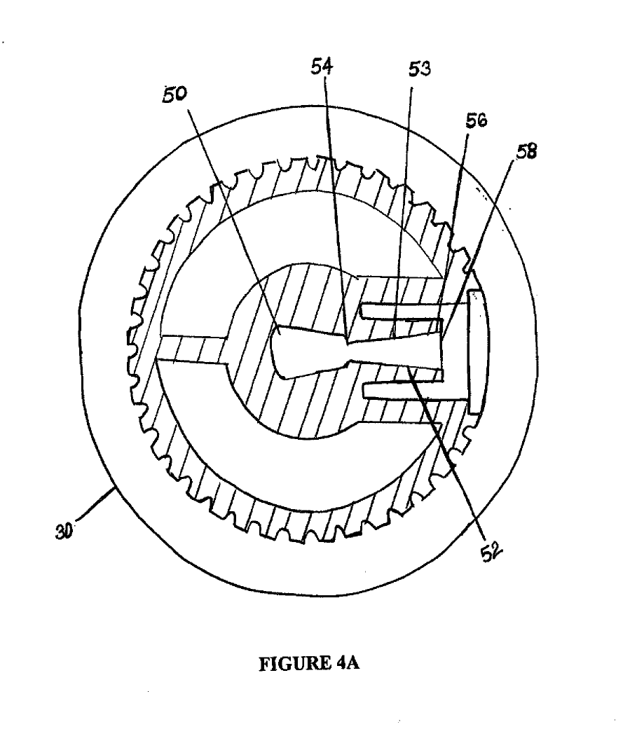

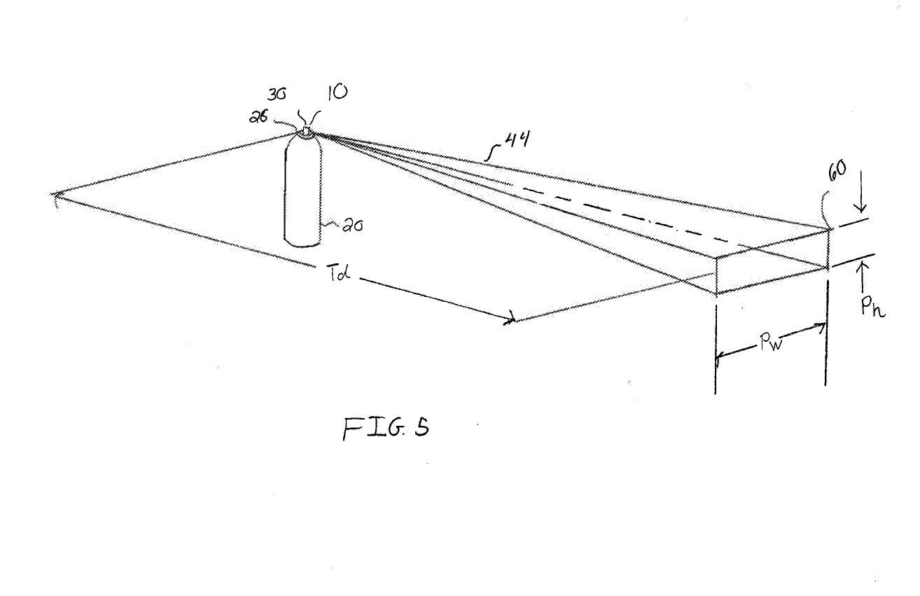

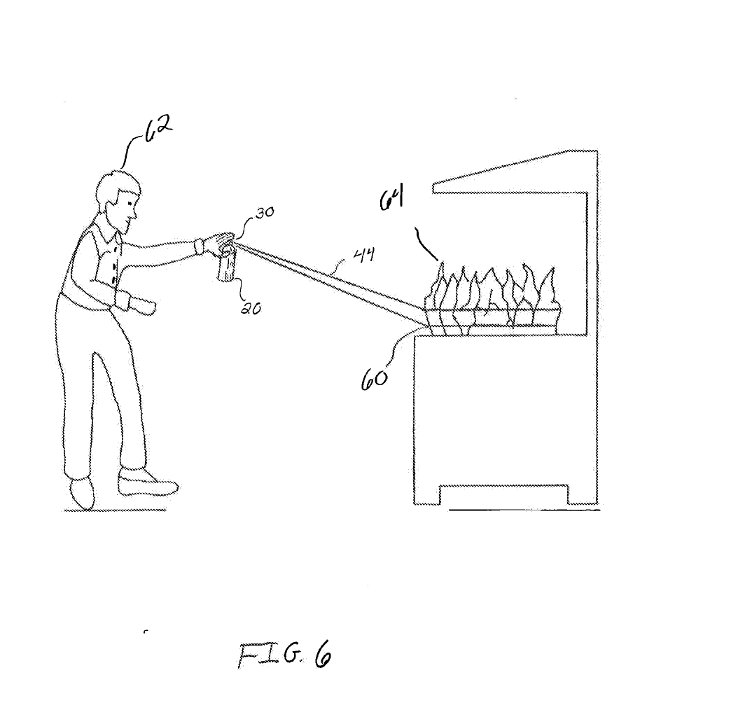

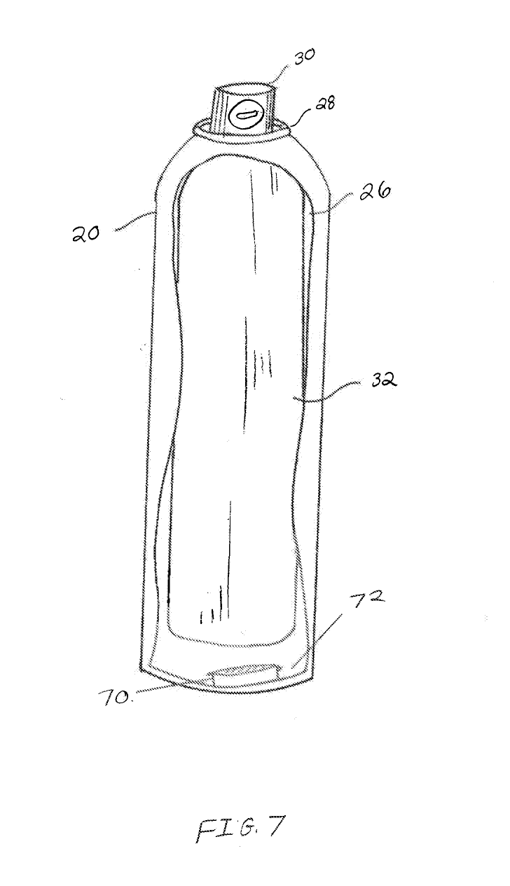

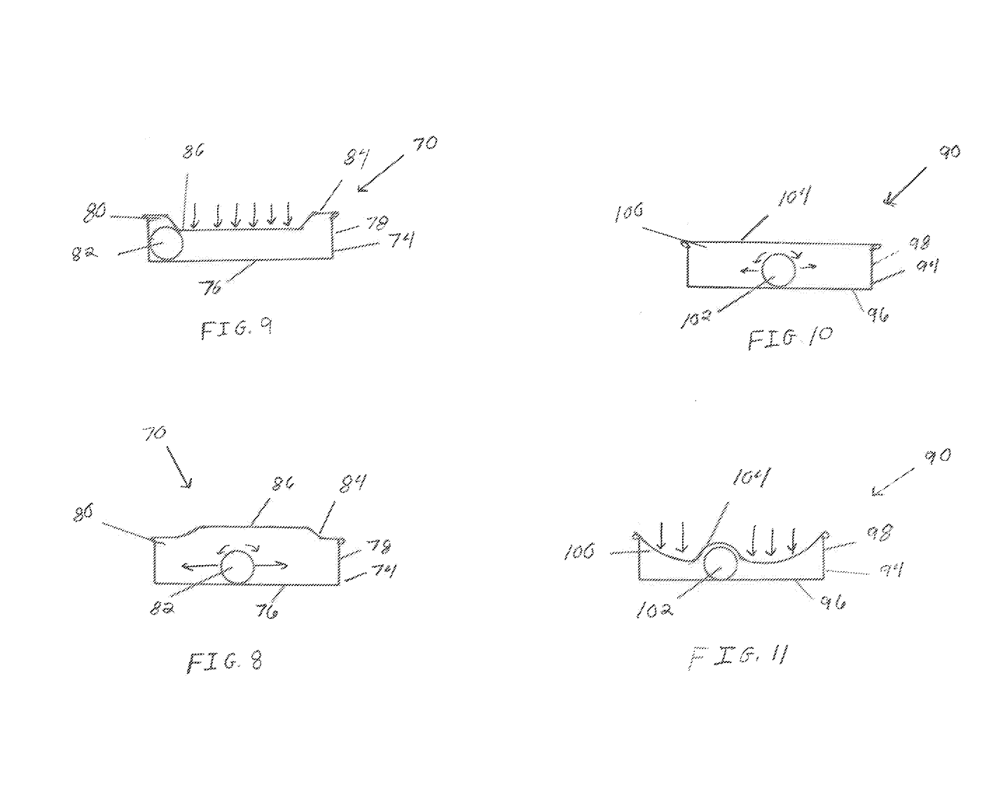

Referring to FIG. 4, a cross-sectional view of the fluid dispensing actuator 30 is provided. The fluid dispensing actuator 30 includes a first passageway 50 configured to connect the fluid dispensing actuator 30 to the downwardly extending stem 46 of the valve member 28. The interior diameter D of a first end 51 of the first circular passageway 50 is sized to securely receive the downwardly extending stem 46 therein, thus securing the fluid dispensing actuator 30 to the valve member 28.

The fluid dispensing actuator 30 includes a second passageway 52 having a first end 54 in fluid communication with the first passageway 50 and a second end 56. The second end 56 of the second passageway 52 fauns an output orifice 58. The output orifice 58 is elongated, having a length L greater then its width W. The second passageway 52 includes a transition region 53, expanding to the second passageway 52 from the first end 54 to the second end 56, forming the output orifice.

Referring to FIG. 4A, the transition region is a substantially linear transition region 53 from a substantially circular first end 54 to the second end 56, the elongated output orifice 58. However, it is completed that the transition region 53 can be non linear. For example, the transition region 53 can include arcuate sidewalls, forming an arcuate transition from the first end 54 to the second end 56 of the second passage 52. Alternatively, the transition region 53 can be a step transition region where the second passageway 52 transitions from the first end 54 to the second end 56 utilizing a step pattern, namely a changing of the second passageway's 53 geometry at discrete interval.

Referring also to FIG. 1, the elongated output orifice 58 is depicted on the fluid dispensing actuator 30, where the length L of the elongated output orifice 58 is oriented substantially orthogonal to a longitudinal axis A of the container 20. In this manner, the elongated output orifice 58 dispenses the contents 44 in substantially planar pattern, where the planar pattern is substantially orthogonal to the longitudinal axis A of the container 20.

However, it is contemplated that the orientation of the elongated output orifice 58 on the fluid dispensing actuator 30 can be non-orthogonal to the longitudinal axis A of the container 20. In exemplary embodiments, the length L of the elongated output orifice 58 can be parallel, at an acute angel, or at an obtuse angle with the longitudinal axis A of the container 20. It is further contemplated, that the elongated output orifice 58 can be rotateably connected to the fluid dispensing actuator 30, such that the orientation of the length L of the elongated output orifice 58 with respect to the longitudinal axis A of the container 20 is adjustable.

Alternatively, a nozzle cap can be rotateably connected to the fluid dispensing, actuator 30. The nozzle cap can includes a plurality of different nozzle orifices, such that the nozzle cap can be selectively rotated to align a specific orifice with the second end 56 of the second passage 52. The plurality of different nozzle orifice can include different sized, shaped, and oriented orifices.

Referring to FIG. 5, in operation when the fire extinguisher 10 is positioned a distance T_{d} from a target area, the elongated output orifice 58 expels the contents 44 of the bag 32 in a substantially planar pattern 60 at the target area, where the planer pattern 60 has a planar width P_{w} greater then the planar height Pₕ.

In an exemplary embodiment, the first end 54 of the second passageway 52 has a diameter of about 0.035 in.+/−0.0010 in. The output orifice 58 has a length L of about 0.075 in.+/−0.010 in. and a width W of about 0.035 in.+/−0.010 in. Where the transition region 53 is substantially linear transition region from the first end 54 of the second circular passageway 52 to the output orifice 58. When the fire extinguisher 10 is positioned a distance T_{d} of about 48 in. from a target area, the elongated output orifice 58 expels the contents 44 is a substantially planar pattern 60 at the target area, having a planar width P_{w} of about 12 in. and a planar height Pₕ of about 3 in.

The contents 44 of the bag 32 is liquid wet chemical fire extinguishing agent formulated to extinguish small fires, such as house hold cooking oil or grease fires, grill fires, electrical fires, automobile file, and the like. As previously discussed, the bag 32 isolates the liquid wet chemical fire extinguishing agent 44 from the propellant 48. In this manner, the propellant 48 is not dispensed with the liquid wet chemical fire extinguishing agent 44, which reduces instance of “flare up” upon an initial application of the liquid wet chemical fire extinguishing spray 44 on a fire.

### EXAMPLE 1

The liquid wet chemical fire extinguishing agent 44 includes the following ingredients:

| | |
|---|---|
| CH₃CHOHCO₂H (Lactic Acid) | 17-43 vol. % |
| KOH (Potassium Hydroxide) | 18-48 vol. % |
| H₂O | Balance of volume |

### EXAMPLE 2

The liquid wet chemical fire extinguishing spray 44 includes the following ingredients:

| | |
|---|---|
| CH₃CHOHCO₂H (Lactic Acid) | 17-43 vol. % |
| KOH (Potassium Hydroxide) | 18-48 vol. % |
| K2CO3 (Potassium Carbonate) | 0-23 vol. % |
| KHCO3 (Potassium Bicarbonate) | 0-23 vol. % |
| H₂O | Balance of volume |

### EXAMPLE 3

The liquid wet chemical fire extinguishing agent 44 includes the following ingredients:

| | |
|---|---|
| CH₃CHOHCO₂H (Lactic Acid) | 27.892 vol. % |
| KOH (Potassium Hydroxide) | 33.687 vol. % |
| K2CO3 (Potassium Carbonate) | 7.366 vol. % |
| KHCO3 (Potassium Bicarbonate) | 3.925 vol. % |
| H₂O | Balance of volume |

### EXAMPLE 4

The liquid wet chemical fire extinguishing agent 44 includes the following ingredients:

| | |
|---|---|
| CH₃CHOHCO₂H (Lactic Acid) | 28.11 vol. % |
| KOH (Potassium Hydroxide) | 33.56 vol. % |
| K2CO3 (Potassium Carbonate) | 7.55 vol. % |
| KHCO3 (Potassium Bicarbonate) | 21.54 vol. % |
| H₂O | Balance of volume |

In a further embodiment, the liquid wet chemical fire extinguishing agent 44 can include a foaming agent formed of an aqueous solution including a surfactant. The surfactant can be a detergent or other known commercial foam producer. Additional surfactants are disclosed in U.S. Pat. Nos. 4,359,096; 4,536,318; 4,599,188; and 4,565,647 the contents of which are incorporated by reference in their entirety.

### EXAMPLE 5

The liquid wet chemical fire extinguishing agent 44 with foaming agent includes the following ingredients:

| | |
|---|---|
| CH₃CHOHCO₂H (Lactic Acid) | 17-43 vol. % |
| KOH (Potassium Hydroxide) | 18-48 vol. % |
| Fire Extinguishing Foam | 0-22 vol. % |
| H₂O | Balance of volume |

### EXAMPLE 6

The liquid wet chemical fire extinguishing spray 44 with foaming agent includes the following ingredients:

| | |
|---|---|
| CH₃CHOHCO₂H (Lactic Acid) | 17-43 vol. % |
| KOH (Potassium Hydroxide) | 18-48 vol. % |
| K2CO3 (Potassium Carbonate) | 0-23 vol. % |
| KHCO3 (Potassium Bicarbonate) | 0-23 vol. % |
| Fire Extinguishing Foam | 0-22 vol. % |
| H₂O | Balance of volume |

### EXAMPLE 7

The liquid wet chemical fire extinguishing agent 44 with foaming agent includes the following ingredients:

| | |
|---|---|
| CH₃CHOHCO₂H (Lactic Acid) | 27.892 vol. % |
| KOH (Potassium Hydroxide) | 33.687 vol. % |
| K2CO3 (Potassium Carbonate) | 7.366 vol. % |
| KHCO3 (Potassium Bicarbonate) | 3.925 vol. % |
| Fire Extinguishing Foam | 6.927 vol. % |
| H₂O | Balance of volume |

### EXAMPLE 8

The liquid wet chemical fire extinguishing agent 44 with foaming agent includes the following ingredients:

| | |
|---|---|
| CH₃CHOHCO₂H (Lactic Acid) | 28.11 vol. % |
| KOH (Potassium Hydroxide) | 33.56 vol. % |
| K2CO3 (Potassium Carbonate) | 7.55 vol. % |
| KHCO3 (Potassium Bicarbonate) | 21.54 vol. % |
| Fire Extinguishing Foam | 6.71 vol. % |
| H₂O | Balance of volume |

The Fire Extinguishing Foam agent can include the following ingredient:

| | |
|---|---|
| H₂O | 95-99 vol. % |
| Surfactant | 1-5 vol. % |

Referring to FIG. 6, in a method of use the fire extinguisher 10 is used to extinguish a kitchen cooking fire. The user 62 holds the container 20 in one hand, directing the output orifice 58 of the fluid dispensing actuator 30 toward the fire. The user depresses the fluid dispensing actuator 30, opening the valve member 28 to dispense the liquid wet chemical fire extinguishing agent 44 onto the fire through the output orifice 58. The liquid wet chemical fire extinguishing agent 44 is expelled in a substantially planar pattern 60 directed at the fire 64. As the liquid wet chemical fire extinguishing agent 44 and the propellant 48 are isolated, only the liquid wet chemical fire extinguishing agent 44 is dispensed into the fire, thus reducing the change of a flare up.

The container 20, bag 32, and fluid dispensing actuator 30 combination provide the additional benefit of having an increased discharge time when compared to small volume extinguishers. For example, a small volume dry chemical fire extinguisher, such as a 1 lb. 2B:C or 5B:C fire extinguisher, has a discharge time of about eight seconds. In contrast, where fire extinguisher 10 is sized to contain fourteen fluid ounces (14 fl oz) of the liquid wet chemical fire extinguishing agent 44, the fire extinguisher 10 has a discharge time of about thirty-two seconds, roughly four (4) times that of the small volume extinguishers.

Similarly, a large volume fire extinguisher, such as a 5 lb. 3A 40B:C fire extinguisher has a discharge time of about thirteen seconds. In contrast, where fire extinguisher 10 is sized to contain fourteen fluid ounces (14 fl oz) of the liquid wet chemical fire extinguishing agent 44, the fire extinguisher 10 has a discharge time of about thirty-two seconds, roughly two and a half (2.5) times that of the large volume extinguisher.

Referring to FIG. 7, the fire extinguisher 10 can further include an internal pressure indicator 70, the placement of which can preclude the need for an external pressure indictor or an pressure probe position through a sidewall of the container 20. The pressure indicator 70 can be mounted to an inner surface 72 of the interior space 26 of the cylindrical container 20. The pressure indicator 70 is configured to determine whether a pressure in the container 20 is above or below a specified operational pressure. If the pressure in the container is below the specified operational pressure, the pressure indicator 70 can provide an indication to a user

Referring to FIGS. 8 and 9, in an embodiment the pressure indicator 70 includes a base 74 having a bottom surface 76 with an upwardly extending cylindrical wall 76 defining an interior space 78 and an open end 80. A ball 82 is positioned within the interior space 78 of the base 74, where a substantially rigid cover 84 is utilized to seal the open end 80 of the base 74. The substantially rigid cover 84 includes a moveable section 86 which is selectively positinable between a first position and a second position. In the first position, as shown in FIG. 8, the ball 82 is free to move within the base 74, causing a rattling sound when shaken. In the second position, as shown in FIG. 9, the moveable section 86 of the substantially rigid cover 84 is pressed against the ball 82, preventing movement of the ball 82 within the base 74 when shaken.

The positioning, movement, of the moveable section 86 of the substantially rigid cover 84 is caused by a pressured differential between the pressure within the sealed pressure indictor 70 and the pressure outside the sealed pressure indicator 70. When the pressure inside the sealed pressure indicator 70 is greater than pressure outside the sealed pressure indicator 70, the pressure differential moves the moveable section 86 into the first portion. When the pressure inside the sealed pressure indicator 70 is less than pressure outside the sealed pressure indicator 70, the pressure differential moves the moveable section 86 into the second portion.

In an exemplary method of use, the pressure indicator 70 is used to verify that there is sufficient pressure in the container 20 to operate the fire extinguisher 10. The ball 82 is sealed, with the substantially rigid cover 84, in the base 74, where the pressure in the sealed pressure indictor 70 is at the operating pressure, for example at 95 PSA. The moveable section 86 of the substantially rigid cover 84 is moved to the first position. To move the moveable section 86 of the substantially rigid cover 84 from the first position to the second position an external pressure greater then about 95 PSI is required to overcome the internal pressure in the pressure indicator 70.

With the pressure indicator 70 mounted to the inner surface 72 of the interior space 26 of the cylindrical container 20, the fire extinguisher 10 is pressurized with propellant to about 130 PSI. As the pressure of the propellant is in excess of the internal pressure of the pressure indicator 70, namely 95 PSI, the moveable section 86 is moved from the first position to the second position, preventing movement of the ball 82 within the pressure indicator 70. If over time, or through use, the pressure of the propellant falls below the 95 PSI internal pressure of the pressure indicator 70, the moveable section 86 of the substantially rigid cover 84 moves from the second position to the first position, freeing the ball 82 for movement within the pressure indicator 70.

In this manner, a user can verify that the pressure in the fire extinguisher 10 is above an operating pressure by shaking the fire extinguisher 10. Specifically, a rattling sound, caused by a movement of the ball 82 within the pressure indicator 70, would indicate that the pressure in the fire extinguisher 10 is below the operating pressure. A lack of a rattling sound, indicating that the ball 82 is captured with the pressure indicator 70, would indicate that the pressure in the fire extinguisher 10 is at or above the operating pressure.

Alternatively, the moveable section 86 can be biased to the first position, such that an external pressure greater then a biasing force is required to move the moveable section 86 from the first position to the second position. When the external pressure is below the biasing force, the moveable section 86 is biased from the second position to the first position.

In an exemplary method of use, the pressure indicator 70 is used to verify that there is sufficient pressure in the container 20 to operate the fire extinguisher 10. The ball 82 is sealed, with the substantially rigid cover 84, in the base 74, where the pressure in the sealed pressure indictor 70 can substantially equal to atmospheric pressure, or at least less than the operating pressure. The moveable section 86 of the substantially rigid cover 84 is biased to the first position. To move the moveable section 86 of the substantially rigid cover 84 from the first position to the second position an external pressure greater then about 95 PSI is required to overcome the biasing force.

With the pressure indicator 70 mounted to the inner surface 72 of the interior space 26 of the cylindrical container 20, and the fire extinguisher 10 is pressurized with propellant to about 130 PSI. As the pressure of the propellant is in excess of the required extern pressure to overcome the biasing force, namely 95 PSI, the moveable section 86 is moved from the first position to the second position, preventing movement of the ball 82 within the pressure indicator 70. If over time, or through use, the pressure of the propellant falls below the required external pressure of 95 PSI, the moveable section 86 of the substantially rigid cover 84 moves from the second position to the first position, freeing the ball 82 for movement within the pressure indicator 70.

In this manner, a user can verify that the pressure in the fire extinguisher 10 is above the operating pressure by shaking the fire extinguisher 10. Specifically, a rattling sound, caused by a movement of the ball 82 within the pressure indicator 70, would indicate that the pressure in the fire extinguisher 10 is below the operating pressure. A lack of a rattling sound, indicating that the ball 82 is captured with the pressure indicator 70, would indicate that the pressure in the fire extinguisher 10 is at or above the operating pressure.

Referring to FIGS. 10 and 11, in another embodiment the pressure indicator 90 includes a base 94 having a bottom surface 96 with an upwardly extending cylindrical wall 96 defining an interior space 98 and an open end 100. A ball 102 is positioned in the interior space 98 of the base 94, where a flexible or semi-rigid cover 104 is utilized to seal the open end 100 of the base 94. At least a portion of the flexible or semi-rigid cover 104 is moveable between a first state and a second state. In the first state, as shown in FIG. 10, the ball 102 is free to move within the base 94, causing a rattling sound when shaken. In the second state, as shown in FIG. 11, at least a portion of the flexible or semi-rigid cover 104 is compressed against the ball 102, preventing movement of the ball 102 within the base. 94 when shaken.

The movement of the flexible or semi-rigid cover 104 is caused by a pressured differential between the pressure within the sealed pressure indictor 90 and the pressure outside the sealed pressure indicator 90. When the pressure inside the sealed pressure indicator 90 is greater than pressure outside the sealed pressure indicator 70, the pressure differential moves, extends, the flexible or semi-rigid cover 104 into the first state. When the pressure inside the sealed pressure indicator 90 is less than pressure outside the sealed pressure indicator 90, the pressure differential moves, compresses, flexible or semi-rigid cover 104 into the second state.

In an exemplary method of use, the pressure indicator 90 is used to verify that there is sufficient pressure in the container 20 to operate the fire extinguisher 10. The ball 102 is sealed, with the flexible or semi-rigid cover 104, in the base 94, where the pressure in the sealed pressure indictor 90 is at the operating pressure, for example at 95 PSA. The flexible or semi-rigid cover 104 is initially in the first state. To move the flexible or semi-rigid cover 104 from the first state to the second state an external pressure greater then about 95 PSI is required to overcome the internal pressure in the pressure indicator 90.

With the pressure indicator 90 mounted to the inner surface 92 of the interior space 26 of the cylindrical container 20, and the fire extinguisher 10 is pressurized with propellant to about 130 PSI. As the pressure of the propellant is in excess of the internal pressure of the pressure indicator 90, namely, 95 PSI, the flexible or semi-rigid cover 104 is moved from the first state to the second state, preventing movement of the ball 102 within the pressure indicator 90. If over time, or through use, the pressure of the propellant falls below the 95 PSI internal pressure of the pressure indicator 90, the flexible or semi-rigid cover 104 moves from the second state to the first state, freeing the ball 102 for movement within the pressure indicator 90.

In this manner, a user can verify that the pressure in the fire extinguisher 10 is above the operating pressure by shaking the fire extinguisher 10. Specifically, a rattling sound, caused by a movement of the ball 102 within the pressure indicator 90, would indicate that the pressure in the fire extinguisher 10 is below the operating pressure. A lack of a rattling sound, indicating that the ball 102 is captured with the pressure indicator 90, would indicate that the pressure in the fire extinguisher 10 is at or above the operating pressure.

The pressures indicated in the above embodiment are only exemplary in nature, and other pressures are also contemplated.

All references cited herein are expressly incorporated by reference in their entirety.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A spray dispenser comprising:
a container;
a valve assembly affixed to the container;
a actuator connected in fluid communication to the valve assembly;
a propellant disposed within the container; and
a pressure indicator disposed within the container.

2. A spray dispenser as set forth in claim 1, where the pressure indicator is contained entirely within the container.

3. A spray dispenser as set forth in claim 2, further comprising a bag positionable within the container, the bag connected in fluid communication to the valve assembly opposite the actuator.

4. A spray dispenser as set forth in claim 3, further comprising a liquid wet chemical fire extinguishing agent disposed within the bag, isolating the liquid wet chemical fire extinguishing agent from the propellant.

5. A spray dispenser as set forth in claim 4, the liquid wet chemical fire extinguishing agent comprising:
CH₃CHOHCO₂H (Lactic Acid);
KOH (Potassium Hydroxide); and
H₂O.

6. A fire extinguisher comprising:
a container;
a valve assembly affixed to the container;
a actuator connected in fluid communication to the valve assembly, the actuator having an elongated output orifice;
a liquid wet chemical fire extinguishing agent disposed within the container;
a propellant disposed within the container; and
a pressure indicator disposed within the container.

7. A fire extinguisher as set forth in claim 6, wherein the container defines a longitudinal axis, and the elongated output orifice is substantially orthogonal to the longitudinal axis.

8. A fire extinguisher as set forth in claim 6, wherein the actuator expels the liquid wet chemical fire extinguishing agent in a substantially planar pattern.

9. A fire extinguisher as set forth in claim 6, further comprising a bag positionable within the container, the bag connected in fluid communication to the valve assembly opposite the actuator, wherein the liquid wet chemical fire extinguishing agent is disposed within the bag, isolating the liquid wet chemical fire extinguishing agent from the propellant.

10. A fire extinguisher as set forth in claim 6, the liquid wet chemical fire extinguishing agent comprising:
CH₃CHOHCO₂H (Lactic Acid);
KOH (Potassium Hydroxide); and
H₂O.

11. A fire extinguisher as set forth in claim 10, wherein the liquid wet chemical fire extinguishing agent comprises:
about 17-43 vol. % of CH₃CHOHCO₂H (Lactic Acid);
about 18-48 vol. % of KOH (Potassium Hydroxide); and
H₂O.

12. A fire extinguisher as set forth in claim 10, the liquid wet chemical fire extinguishing agent further comprising a fire extinguishing foam.

13. A fire extinguisher as set forth in claim 6, the liquid wet chemical fire extinguishing agent comprising:
about 17-43 vol. % of CH₃CHOHCO₂H (Lactic Acid);
about 18-48 vol. % of KOH (Potassium Hydroxide);
about 0-23 vol. % of K2CO3 (Potassium Carbonate);
about 0-23 vol. % of KHCO3 (Potassium Bicarbonate); and
H₂O.

14. A fire extinguisher as set forth in claim 13, wherein the liquid wet chemical fire extinguishing spray comprises:
about 28 vol. % of CH₃CHOHCO₂H (Lactic Acid);
about 37 vol. % of KOH (Potassium Hydroxide);
about 7 vol. % of K2CO3 (Potassium Carbonate);
about 21 vol. % of KHCO3 (Potassium Bicarbonate); and
H₂O.

15. A fire extinguisher as set forth in claim 13, the liquid wet chemical fire extinguishing, agent further comprising, a fire extinguishing foam.

16. A pressure indicator comprising:
a base including a bottom surface and sidewalls defining an open end.
a ball positionable in the base; and
a cover positioned over and sealing the open end of the base, wherein at least a portion of the cover is moveable between a first position and a second position.

17. A pressure indicator as set forth in claim 16, wherein when at least a portion of the cover is in the first position the ball is free to move within the base, and when at least a portion of the cover is in the second position the ball is prevented from moving within the base.

18. A pressure indicator as set forth in claim 16, wherein at least a portion of the cover is in the first position when an external pressure on the cover is less than an internal pressure in the sealed base; and at least a portion of the cover is in the second position the external pressure on the cover is greater than the internal pressure in the sealed base.

19. A pressure indicator as set forth in claim 16, wherein at least a portion of the cover is biased in the first position by biasing force, and at least a portion of the cover is in the second position when an external pressure on the cover exerts a force on the cover in excess of the biasing force.

20. A pressure indicator as set forth in claims 15, where the cover is made or a rigid, semi-rigid, or flexible material
